(19) United States
(12) Patent Application Publication
(10) Pub. No.: US 2010/0214690 A1
(43) Pub. Date: Aug. 26, 2010

(54) ROLLER GUIDE FOR MAGNETIC TAPE WITH MULTIPLE GUIDING SECTIONS

(75) Inventors: Evangelos S. Eleftheriou, Rueschlikon (CH); Walter Haeberle, Waedenswil (CH); Venkataraman Kartik, Zurich (CH); Mark Alfred Lantz, Adliswil (CH)

Correspondence Address: Scully, Scott, Murphy & Presser, P.C., 400 Garden City Plaza, Suite 300, Garden City, NY, 11530, US

(73) Assignee: INTERNATIONAL BUSINESS MACHINES CORPORATION, Armonk, NY (US)

(21) Appl. No.: 12/393,707

(22) Filed: Feb. 26, 2009

(51) Int. Cl. G11B 5/584

(52) U.S. Cl. 360/77.12; G9B/5.203

(57) ABSTRACT

A device for guiding a magnetic tape in a data storage drive including a cylindrical body rotatable about a longitudinal axis. The cylindrical body having opposing ends and defining a surface area for mating with a magnetic tape. A curved section at opposite ends of the cylindrical body is contiguous with the surface area of the cylindrical body. A plurality of vents in the cylindrical body allow air flow therethrough between the surface area and the tape. The amount of air flow between the cylindrical body and the tape produces varying frictional forces on the tape such that the tape is biased to a nominal position on the cylindrical body by air pressure on the tape resulting from the air flow interaction with the curved sections.

### CROSS REFERENCE TO RELATED APPLICATION

This application is related to commonly-owned, co-pending U.S. patent application Ser. No. 12/393,578 filed on Feb. 26, 2009, which is hereby expressly incorporated by reference in its entirety as if fully set forth herein.

### FIELD OF THE INVENTION

The present invention relates to an apparatus and method directed to magnetic storage tape devices, and more particularly, relates to an apparatus and method for guiding a magnetic tape in a magnetic storage tape device.

### BACKGROUND OF THE INVENTION

Known magnetic tape data storage cartridges provide long term storage of information Magnetic tape data storage drives read and write data to the magnetic tape data storage cartridges having, for example, a reel to reel design for transporting the tape from one reel to another while a read/write head communicates with the tape. Thus, data/information is written to the magnetic tape data storage cartridge by the magnetic tape data storage drive.

Typically, during use of a tape cartridge the tape is wound from a data cartridge and onto a machine reel by means of motors. During transport, the tape is guided over rollers or stationary guides as well as over a recording head(s). Imperfections of the rollers and reels, in terms of positioning (e.g., the axis of a roller might not be perfectly vertical) or dimensions (e.g., a cylindrical roller or a reel might not have a perfectly circular cross-section), or a number of other possible defects cause the tape to move undesirably in the lateral direction. In order to allow for such lateral motion, the data tracks have to be placed further apart than would be necessary in the absence of such lateral motion.

Thus, it is known that during use of a tape cartridge for storing or retrieving data to the magnetic tape, lateral motion of the magnetic tape occurs during the read/write operations. The lateral motion is undesirable because it imposes constraints on the spacing of data tracks. More specifically, a specified latitude on the tape for read/write operation must be maintained as the lateral motion could result in the read/write head moving outside the data tracks rendering the read/write data operation unsuccessful. For example, the tape may move in the lateral direction beyond the range of a read/write head of a magnetic tape data storage drive, and thus data would not be written or retrieved as desired. Therefore, there is a need to reduce and/or eliminate lateral movement because a real storage density is reduced.

Current known attempts to remedy the problems caused by lateral movement of the magnetic tape in magnetic tape data storage drives typically include flanges used in stationary guides or roller guides in order to constrain the tape's motion. However, a disadvantage of the flanges is that they cause undesirable wear of the tape's edge over a period of time. Additionally, the problems caused by flanges is exacerbated when used with thinner media as wear of the thinner media caused by the flanges occurs in a shorter period of time. In addition, impacts between the tape and the flanges cause high-frequency excitation (or vibration) which is difficult for the track following servo mechanism or system to compensate for and correct. Vibration makes it difficult for a tape to track on a cylinder surface, and requires a servo mechanism or system to compensate/correct for the vibration. Impacts between a tape's edge and other surfaces such as flanges on guides or packs or reels generate excitations that span a large frequency range. A servo system/mechanism has a mechanical limitation on the highest frequency that it can track (bandwidth). While the components of such excitations that are at frequencies below this bandwidth limit are compensated for by the servo system, the residual frequency components above this limit cause undesirable tape motion.

The stroke of the actuator refers to how far it is designed to move, and directly relates to the largest motion that it can compensate for. Tape motion beyond the stroke cannot be followed. Tape skew refers to the angle that the tape makes with respect to the transport direction. Both lateral tape motion as well as tape skew arise from the imperfections in the tape path (as described above), and both cause errors in the recording process (including the read-after-write verification). Large values of lateral motion and skew can especially arise when the outer flanges are absent, as in the case of flangeless rollers.

Other attempts to remedy deficiencies in current magnetic tape data storage drives include flangeless roller designs. However, high amplitude motion of the tape beyond the stroke (or reach) of the track following actuator results in data loss. In addition, large unconstrained motion results in unacceptably large values of tape skew which prevents read after write verification, and can further result in a write stop condition.

It would therefore be desirable to provide a guide apparatus and method which maintains the magnetic tape in a designated position within specified margins of lateral motion. There is further a need to minimize wear on the magnetic tape while maintaining the tape position. It would further be desirable to improve control of tape motion on a guide in a magnetic tape data storage drive. There is also a need to reduce tape wear from flanges used to maintain tape position and/or to eliminate flanges from a guide device or tape data storage drive while providing and maintaining tape positioning.

### SUMMARY OF THE INVENTION

In an aspect of the invention, a device for guiding a magnetic tape in a data storage drive including a cylindrical body rotatable about a longitudinal axis. The cylindrical body has opposing ends and defines a surface area for mating with a magnetic tape. A curved section at each of the opposing ends of the cylindrical body and each curved section are contiguous with the surface area of the cylindrical body. The surface area allows air flow between the surface area and the tape, A plurality of vents are in a section of the surface area of the cylindrical body. The vents allow air flow therethrough. An unvented section of the surface area wherein the tape at least partially covers the vented and unvented sections of the surface area such that air pressure from the air flow between the tape and the vented section is less than the air pressure between the tape and the unvented section.

In a related aspect of the invention, a portion of the tape over the vented surface area contacts the surface area of the cylindrical body and another portion of the tape over the unvented surface area is lifted off the unvented surface area by the air flow. The air flow between the curved sections and the tape may produce air pressure on the tape when the tape is over the curved sections such that the tape is biased to a nominal position away from the curved sections on the cylindrical body by the air pressure exerted on the tape resulting from the air flow interaction with the curved sections. The curved section may be concave or convex. The vent may be a V shaped groove. A plurality of unvented sections may have the vented section therebetween. The curved section may be at an acute angle from the longitudinal axis. The curved section may be at an angle of more than 30 degrees from the longitudinal axis.

In another aspect of the invention, a method for guiding a magnetic tape in a data storage drive includes: rotating a cylindrical body about a longitudinal axis, the cylindrical body having opposing ends and defining a surface area for mating with a magnetic tape; flowing air between the surface area and the tape over a curved section at each of the opposing ends of the cylindrical body, and each curved section being contiguous with the surface area of the cylindrical body; flowing air through a plurality of vents in a section of the surface area of the cylindrical body; and covering at least partially the vented and unvented sections of the surface area using the tape such that air pressure from the air flow between the tape and the vented section is less than the air pressure between the tape and the unvented section.

In a related aspect, the method further includes: contacting a portion of the tape over the vented surface on the surface area of the cylindrical body; and lifting another portion of the tape over the unvented surface area using the air flow. The method further includes: providing air pressure on the tape when the tape is over the curved sections using the air flow between the curved sections and the tape; and biasing the tape to a nominal position away from the curved sections on the cylindrical body by the air pressure exerted on the tape resulting from the air flow interacting with the curved sections.

In another aspect of the invention, a system for guiding a magnetic tape in a data storage drive includes a tape cartridge for removable mating a magnetic tape with a tape head. A device for guiding a magnetic tape in a data storage drive includes a cylindrical body rotatable about a longitudinal axis. The cylindrical body has opposing ends and defines a surface area for mating with a magnetic tape. A curved section at each of the opposing ends of the cylindrical body and each curved section are contiguous with the surface area of the cylindrical body. The surface area allows air flow between the surface area and the tape. A plurality of vents are in a section of the surface area of the cylindrical body. The vents allow air flow therethrough. An unvented section of the surface area wherein the tape at least partially covers the vented and unvented sections of the surface area such that air pressure from the air flow between the tape and the vented section is less than the air pressure between the tape and the unvented section. The system may further include the tape being rolled on reels and the tape motion and speed being controlled by a controller managing allowing a user to manage the tape motion and speed using motors connected to the reels.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a side elevational view of a guide device according to an embodiment of the present invention and a cross section of a magnetic tape in spaced relation thereto;

FIG. 2 is a side elevational view of the guide device and magnetic tape shown in FIG. 1 depicting the tape shifted laterally from a nominal position;

FIG. 3 is a side elevational view of the guide device and magnetic tape shown in FIG. 2, depicting the tape retuned to the nominal position;

FIG. 4 is a enlarged side elevation view of the guide device and cross section of the tape shown in FIG. 1 depicted rotated ninety degrees;

FIG. 5 is a side elevational view of another embodiment of a guide device depicting V shaped grooves; and

FIG. 6 is a schematic block diagram of a magnetic tape data storage system according to an embodiment of the invention, depicting the guide device shown in FIGS. 1-5 positioned within the system.

### DETAILED DESCRIPTION OF THE INVENTION

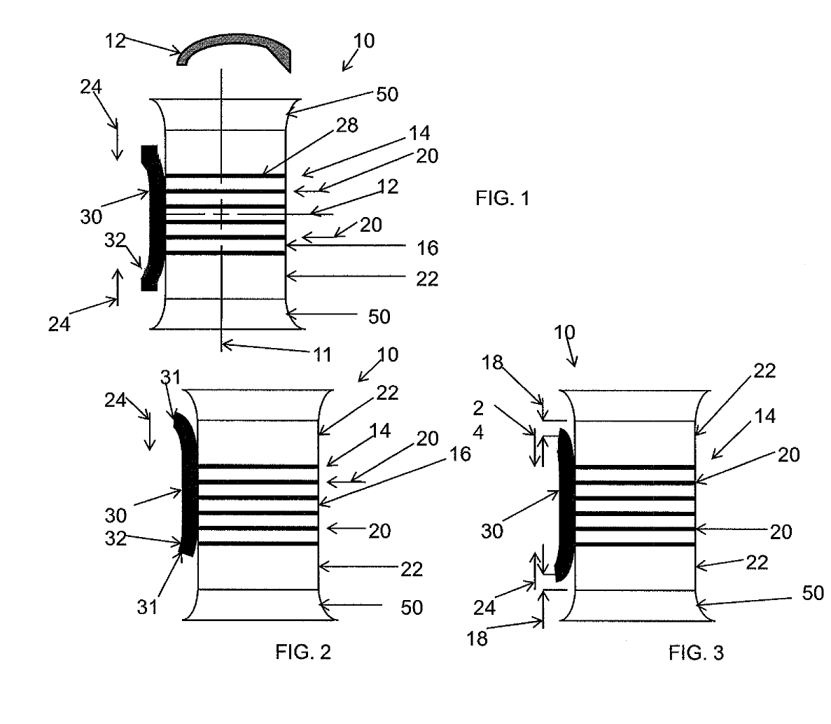

Referring to FIGS. 1-3, a guide device 10 for a magnetic tape data storage drive according to one embodiment of the present invention includes two sets of guiding surfaces. A guiding surface includes a cylindrical central section 14. The cylindrical central section 14 includes venting channels or grooves 28 that bleed air between magnetic tape 30 (shown exaggerated in width and in cross section to depict the grooves 28) and the guide device 10 providing for an air flow 20. The tape in normal operation would partially wrap around the cylinder 14, however for illustrative purposes, the tape is shown in cross section to illustrate the grooves 28 and the tapes relation to the cylindrical central section 14. The air flow 20, when bled through the grooves 28, increases frictional forces acting on the magnetic tape 30; while over regions without grooving, results in biasing pressure or forces 24, as explained below. Planar ungrooved surfaces 22 are also part of the cylindrical central section 14 and define a first set of guiding surfaces. The planar ungrooved surfaces 22 are positioned on opposite sides of the grooves 28, and do not include any grooves. The opposing biasing pressure 24 at opposite ends of the device 10 act in concert to maintain the tape 30 in position on the cylindrical central section 14 of the guide device 10, as described in detail below. The desired position of the tape 30 is referred to as a nominal position. In regions with grooving, the air flow is diverted into the grooves, which increases frictional forces due to the absence of air between the tape and the guide surface. In regions without grooving, the air flow generates pressure which acts on the tape.

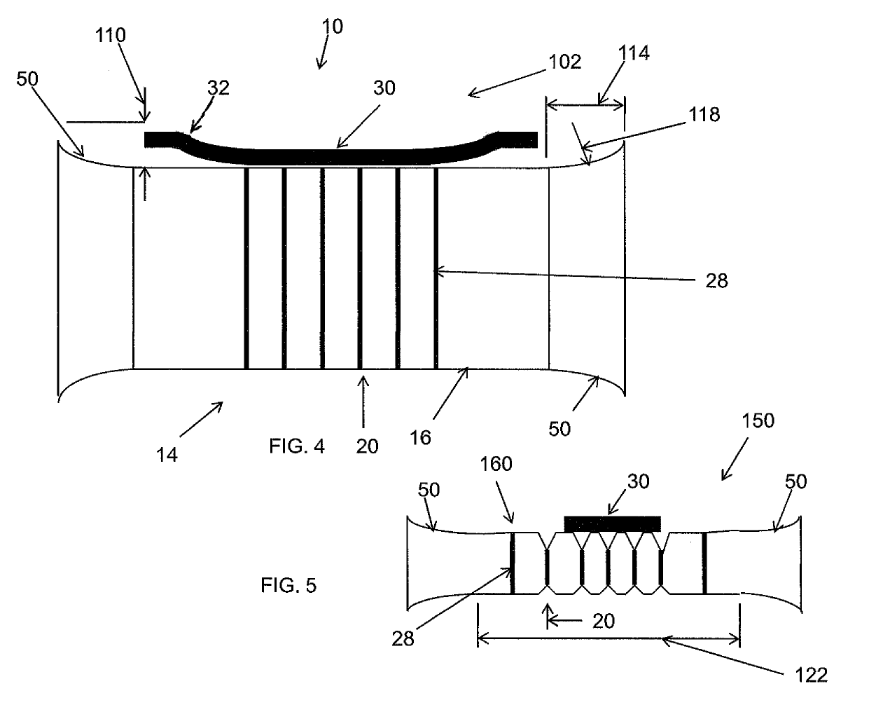

A second set of guiding surfaces include two (or more) curved, ungrooved, guiding sections 50 at both ends of the cylindrical section 14. The curved ungrooved sections 50 extend contiguously from the surface area 16 of the cylindrical section 14. The curved ungrooved sections 50 guide the tape 30 using the bias pressure 24 of the air which is generated between the tape 30 and the curved surface 50. More specifically, the curved ungrooved sections 50 positioned at opposing ends of the cylindrical central section 14 use bias pressure 24 from the air flow 20 (FIG. 4) to continuously direct the tape 30 back towards the center 12 of the cylinder 14 (to the tape's nominal position). The bias force 24 generated by either curved section 50 increases proportionally with the incursion of the tape 30 into the curved section 50. When the tape is at its nominal position, equal incursions of the tape occur in each of the opposing curved sections, and equal and opposite bias forces arise in them, canceling each other. The guide device 10 includes two curved sections 50, however, other embodiments may include more than two curved section, and furthermore, the curved sections may have different geometries, such as, convex, or multiple protrusions. Thereby, the guide device of the present invention eliminates the need for flanges for guiding the tape, and furthermore provides improved control over the tape's motion without damaging the tape.

More specifically, when the tape 30 moves over the planar guiding surfaces 22, air is entrapped between the tape's face and the guiding surfaces 22. The air 20 enters at that interface between the tape 30 and the guide 10 as shown in FIGS. 1-3, i.e., in the direction of the arrows 20, and the air leaves at the opposite interface between the tape 30 and the guide 10 traveling between the tape 30 and the surface 16. Without the grooves 28, the presence of the air 20 results in low friction between the tape and the guiding surface (air bearing), since the tape is floating on a film of air and has no direct mechanical contact with the surface.

More particularly, higher frictional forces are beneficial for preventing the tape 30 from moving undesirably in the lateral direction. In order to generate higher frictional forces, the air bearing (i.e., the air flow 20 under the tape 30) is bled using the venting channels/grooves 28 on the guiding surface 16. The venting channels/grooves 28 provide an alternative path for the air flow rather than directly under the tape 30. Thereby the lack of force under the tape 30 by the air 20, allows the tape 30 to directly contact the guiding surface 16 of the guide device 10 rather than floating on an air film from the air 20 flow because the air 20 flows out through the grooves 28 in a diffuse manner as opposed to a nozzle which concentrates or narrow the air flow to maximize force. With the reduction or even elimination of the air film, direct mechanical contact ensues, thereby generating more friction and preventing lateral motion. Portions of the tape 30 (lifted portions 32) over the ungrooved sections 22 are lifted by the air 20 film therebelow.

Thus, the greater the air 20 flow between the tape 30 and the surface area 16 of the cylindrical section 14, the less the frictional forces between the surface area 16 and the tape 30. Contrarily, the venting channels/grooves 28 provide an alternative path for the air flow 20, which reduces the air flow under the tape 30, allowing the tape 30 to directly contact the guiding surface, rather than floating on an air film, thereby generating higher frictional forces between the tape 30 and the surface area 16.

Referring to the curved ungrooved sections 50 shown in FIGS. 1-3 the air bearing or air film over the smooth curved ungrooved sections 50 exerts a pressure on the tape 30 that acts perpendicular to the surface 16 of the guide 10 and longitudinal axis 11. The following two cases of the guide's 10 surface 16 geometry arise as explained below. The first when the orientation of any portion or section of the guide 10 is parallel to the lateral direction of the tape 30 and the longitudinal axis 11, the direction of air pressure force is perpendicular to the surface 16 of the guide 10 (longitudinal axis 11). Further, the air pressure force exerts no force angularly or perpendicular to the air pressure force perpendicular to the surface 16 and longitudinal axis 11. The above relation prevails over the ungrooved sections 22 of the cylindrical section 14 of the guide 10 which flank the grooved section.

The second, when the orientation of the surface 16 of the guide 10 is not parallel to the tape's lateral direction and the longitudinal axis 11. For example, when the tape 30 has shifted to the curved (concave) surfaces 50 at opposite ends of the cylindrical section 14, as shown in FIG. 3, the air pressure 24 acts angularly (e.g., perpendicularly) to the end 31 of the tape 30 and at an acute angle or parallel with the longitudinal axis 11. The angle can be measured from the end of the curved section to the longitudinal axis 11. Additionally, the angle may include angles from zero at the interface with the cylinder to ninety degrees (including any acute angle, e.g., 30 degrees) or greater than thirty degrees (i.e., an obtuse angle) at the end of the curved section, when measuring the angle between the curved section and the longitudinal axis 11. Thus, the air pressure or bias pressure 24 pushes the tape 30 away from the curved (e.g., concave) section 50 and back towards or into the cylindrical section 14. Therefore, the curved sections 50 at the ends of the guide 10 are used to push the tape 30 back to the center (intersection of longitudinal axis 11 and transverse axis 12) when the tape 30 strays or migrates away from the nominal position.

Thereby, the guide device 10 is designed such that the frictional forces generated over a high friction section, i.e., the grooved part of the cylindrical section 14, control and prevent much of the tape's 30 lateral motion. In the event there is any tape 30 motion not controlled by the frictional forces, the bias pressure 24 from the curved/concave sections 50 push the tape 30 back to the nominal position.

In one embodiment of the present invention, the guide device 10 and a method for maintaining tape position operates using the guide device 10 and the tape 30 in a nominal position as shown in FIGS. 1 and 3, wherein equal size segments 18 (FIG. 3) along the length of the cylindrical central section 14 of the device 10 are on each side of the outer edges 31 of the tape 30. The guiding biasing forces 24 are generated by the air flow 20 interacting with the curved sections 50 (as explained above) which creates the equal and opposite biasing forces 24 on the tape 30. However, if the tape 30 moves laterally, thereby out of the nominal position, for example toward the curved section 50 at one end of the device 10 (as shown in FIG. 2), the bias force 24 generated by the air flow 20 at section 50 pushes the end 31 of the tape 30 back to the nominal position.

Further referring to FIG. 4, the guide device 10 includes the curved guiding section 50 having a specified height 110. The curved section 50 also includes a specified length 114, and a specified radius 118 of the curve of the curved section 50. Additionally, the length of the cylindrical central section 14 may be varied, and the point at which the curved sections 50 begin in relation to the cylindrical central section 14 may also be specified.

Table 1 below summarizes the improvement in lateral tape motion performance, quantified in terms of the 1-sigma value of the measured position error signal (PES), with the use of example rollers of the proposed design. For experimental parameters typical of a commercial tape drive, the proposed design enables a reduction of between 12 and 42% in the PES, depending on the direction and speed of tape transport.

In Table 1 below, common metrics for the lateral tape motion are the absolute lateral motion, measured with respect to some fixed position such as the tape drive, or the relative lateral motion of the tape, known as the PES or position error signal. This PES is the net positioning error of the tape with respect to the track-following mechanism, and is calculated as the difference between the absolute lateral tape motion, and the motion of the track-following system as it tries to ‘follow’ the tape's motion. The PES represents that portion of the lateral tape motion that is the residual of, or not compensated by, the track-following mechanism. The values listed are those lying within the 1-sigma, or first standard deviation, limits of the measured quantity.

TABLE 1
Summary of improvement in 1-sigma position error signal (PES)
performance with the use of example rollers of the proposed design.
The figures in parentheses denote the reduction in PES relative to
the baseline design, for any given combination of operating parameters.

| | Forward Direction | | Reverse Direction | |
|---|---|---|---|---|
| | Baseline | Proposed | Baseline | Proposed |
| | Design | Design | Design | Design |
| Speed 1 | σ = 0.640 μm | 0.378 μm | 0.504 | 0.422 |
| | | (41%) | | (17%) |
| Speed 3 | 0.520 | 0.302 | 0.424 | 0.362 |
| | | (42%) | | (15%) |
| Speed 4 | 0.434 | 0.318 | 0.440 | 0.370 |
| | | (27%) | | (16%) |
| Speed 6 | 0.405 | 0.356 | 0.744 | 0.654 |
| | | (12%) | | (12%) |

Referring to FIG. 5, another embodiment of a guide device 150 (wherein like elements have the same reference numerals as in FIGS. 1-4) according to the present invention may include different shaped grooves 28 on the cylindrical central section 14, in the embodiment shown in FIG. 5, the grooves are V shaped 154 (shown exaggerated). The grooves may also be other geometries such as U shaped. The air flow 20 travels through the V shaped grooves 28 to bleed the air under the tape 30 to reduce air pressure (air bearing/air film) on the tape and increase frictional forces between the tape 30 and the cylindrical surface 16.

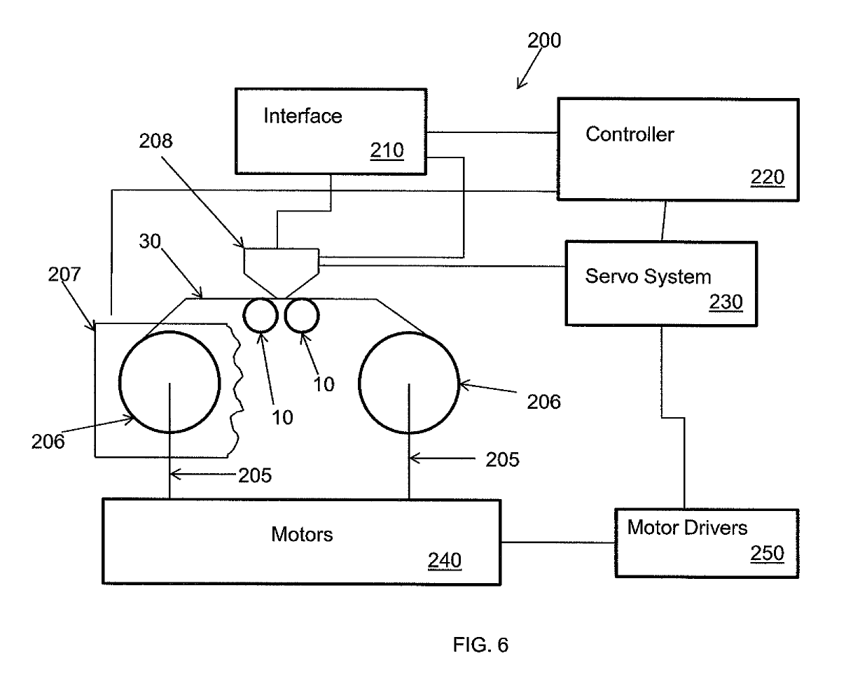

Referring to FIG. 6, a magnetic tape data storage system 200 according to an embodiment of the present invention, includes two guide devices 10 positioned beneath the tape 30 suspended between two reels 206 and a tape cartridge 207 (partially shown). The reels are mounted on rods 205 and the reels are rotated by motors 240 and motor drivers 250. A read/write head 208 reads and/or writes information on the magnetic tape 230 as the tape 30 is moved longitudinally by the motors 240 which rotate the reels 206. The read/write head 208 is electrically connected to an interface 210 for a user to control the system. The interface is electrically connected to a controller 220 to implement the user's instructions in conjunction with a servo system 230.

Thereby, the present invention provides a solution for high-frequency excitation (or vibration). Vibration makes it difficult for the tape 30 to track on the cylinder surface 16. Impacts between the tape's 30 edge and other surfaces such as flanges on guides or packs or reels 206 (as shown in FIG. 6) generate excitations that span a large frequency range. The servo system/mechanism 230 has a mechanical limitation on the highest frequency that it can track (bandwidth). While the components of such excitations that are at frequencies below this bandwidth limit are compensated for by the servo system 230, the residual frequency components above this limit cause undesirable tape motion. The present invention as described in the embodiments above provides for discouraging and eliminating undesirable tape motion.

In the embodiment of the invention described above and shown in FIGS. 1-4, the tape is at a nominal position and no part of the tape is present over the curved sections 50 and therefore no bias pressure is exerted by the air flow on the tape when in the nominal position. In an alternative embodiment, the cylindrical section is shorter (i.e., the curved sections are closer to each other), equal portions of the tape would be present over the curved sections at either end, which would generate equal but opposing bias forces from the air flow interaction with the curved sections. In both of the above situations, when the tape is riding at its nominal position, the only net forces on the tape arise out of the friction generated over the grooved section of the surface area as the tape will contact the surface area. When the tape, for instance, moves upward and away from the nominal position, the portion of the tape that would stray into the curved section or further into the curved section faces a biasing pressure (air pressure) to return to its nominal position

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A device for guiding a magnetic tape in a data storage drive, comprising:
a cylindrical body rotatable about a longitudinal axis, the cylindrical body having opposing ends and defining a surface area for mating with a magnetic tape;
a curved section at each of the opposing ends of the cylindrical body and each curved section being contiguous with the surface area of the cylindrical body, the surface area allowing air flow between the surface area and the tape;
a plurality of vents in a section of the surface area of the cylindrical body, the vents allowing air flow therethrough; and
an unvented section of the surface area, the tape at least partially covers the vented and unvented sections of the surface area such that air pressure from the air flow between the tape and the vented section is less than the air pressure between the tape and the unvented section.

2. The device of claim 1, wherein a portion of the tape over the vented surface area contacts the surface area of the cylindrical body and another portion of the tape over the unvented surface area is lifted off the unvented surface area by the air flow.

3. The device of claim 1, wherein the air flow between the curved sections and the tape produces air pressure on the tape when the tape is over the curved sections such that the tape is biased to a nominal position away from the curved sections on the cylindrical body by the air pressure exerted on the tape resulting from the air flow interaction with the curved sections.

4. The device of claim 1, wherein the curved section is concave or convex.

5. The device of claim 1, wherein the vent is a V shaped groove.

6. The device of claim 1, wherein a plurality of unvented sections have the vented section therebetween.

7. The device of claim 1, wherein the curved section is at an acute angle from the longitudinal axis.

8. The device of claim 1, wherein the curved section is at an angle of more than 30 degrees from the longitudinal axis.

9. A method for guiding a magnetic tape in a data storage drive, comprising:
rotating a cylindrical body about a longitudinal axis, the cylindrical body having opposing ends and defining a surface area for mating with a magnetic tape;
flowing air between the surface area and the tape over a curved section at each of the opposing ends of the cylindrical body, and each curved section being contiguous with the surface area of the cylindrical body;
flowing air through a plurality of vents in a section of the surface area of the cylindrical body; and
covering at least partially the vented and unvented sections of the surface area using the tape such that air pressure from the air flow between the tape and the vented section is less than the air pressure between the tape and the unvented section.

10. The method of claim 9, further comprising:
contacting a portion of the tape over the vented surface on the surface area of the cylindrical body; and
lifting another portion of the tape over the unvented surface area using the air flow.

11. The method of claim 9, further comprising:
providing air pressure on the tape when the tape is over the curved sections using the air flow between the curved sections and the tape; and
biasing the tape to a nominal position away from the curved sections on the cylindrical body by the air pressure exerted on the tape resulting from the air flow interacting with the curved sections.

12. A system for guiding a magnetic tape in a data storage drive, comprising:
a tape cartridge for removable mating a magnetic tape with a tape head;
a cylindrical body rotatable about a longitudinal axis, the cylindrical body having opposing ends and defining a surface area for mating with the magnetic tape;
a curved section at each of the opposing ends of the cylindrical body and each curved section being contiguous with the surface area of the cylindrical body, the surface area allowing air flow between the surface area and the tape;
a plurality of vents in a section of the surface area of the cylindrical body, the vents allowing air flow therethrough; and
an unvented section of the surface area, the tape at least partially covers the vented and unvented sections of the surface area such that air pressure from the air flow between the tape and the vented section is less than the air pressure between the tape and the unvented section.

13. The system of claim 12, wherein a portion of the tape over the vented surface area contacts the surface area of the cylindrical body and another portion of the tape over the unvented surface area is lifted off the unvented surface area by the air flow.

14. The system of claim 12, wherein the air flow between the curved sections and the tape produces air pressure on the tape when the tape is over the curved sections such that the tape is biased to a nominal position away from the curved sections on the cylindrical body by the air pressure exerted on the tape resulting from the air flow interaction with the curved sections.

15. The system of claim 12, wherein the curved section is concave or convex.

16. The system of claim 12, wherein the vent is a V shaped groove.

17. The system of claim 12 wherein a plurality of unvented sections have the vented section therebetween.

18. The system of claim 12, wherein the curved section is at an acute angle from the longitudinal axis.

19. The system of claim 12, wherein the curved section is at an angle of more than 30 degrees from the longitudinal axis.

20. The system of claim 12, further including the tape being rolled on reels and the tape motion and speed being controlled by a controller managing allowing a user to manage the tape motion and speed using motors connected to the reels.
